(19) United States
(12) Patent Application Publication
(10) Pub. No.: US 2025/0391609 A1
(43) Pub. Date: Dec. 25, 2025

(54) ELECTRONIC COMPONENT

(71) Applicant: TDK Corporation, Tokyo (JP)

(72) Inventors: Daisuke HIROTA, Tokyo (JP); Kazuya MIURA, Tokyo (JP); Atsushi TAKEDA, Tokyo (JP)

(73) Assignee: TDK Corporation, Tokyo (JP)

(21) Appl. No.: 19/191,307

(22) Filed: Apr. 28, 2025

(30) Foreign Application Priority Data
Jun. 24, 2024 (JP) 2024-101118

(51) Int. Cl. H01G 4/232; H01G 2/06; H01G 4/008; H01G 4/30

(52) U.S. Cl. CPC H01G 4/2325; H01G 2/065; H01G 4/008; H01G 4/30

(57) ABSTRACT

An element body includes a first side surface and a pair of second side surfaces adjacent to the first side surface and opposing each other. An internal conductor is disposed in the element body. An external conductor is disposed on the element body and includes a glass composition and an electrically conductive metal, the glass composition including SiO₂ and Al₂O₃. The external conductor includes a first region disposed on the first side surface and connected to an end of the internal conductor, and a second region disposed on at least one of the pair of second side surfaces. The glass composition included in the first region has a total content of SiO₂ and Al₂O₃ of 23 mol % or more. The glass composition included in the second region has a total content of SiO₂ and Al₂O₃ of 5 mol % or more and 20 mol % or less.

### CROSS-REFERENCE TO RELATED APPLICATIONS

This application is based upon and claims the benefit of priority from Japanese Patent Application No. 2024-101118, filed on Jun. 24, 2024, the entire contents of which are incorporated herein by reference.

### BACKGROUND

### Field

The present disclosure relates to an electronic component.

### Description of the Related Art

Known electronic components include an element body, an internal conductor disposed in the element body, and an external conductor disposed on the element body and connected to the internal conductor (see, for example, Japanese Unexamined Patent Publication No. S64-65816). The element body includes, for example, a first side surface and a pair of second side surfaces adjacent to the first side surface and opposing each other. The external conductor includes, for example, a first region disposed on the first side surface and connected to an end included in the internal conductor, and a second region disposed on at least one of the pair of second side surfaces. The external conductor includes, for example, a glass composition and an electrically conductive metal.

### SUMMARY

In a configuration in which an electronic component is mounted on an electronic device, an external force acting on the electronic component from the electronic device may act as a stress on the element body. The external force is applied onto the element body through the external conductor. The stress tends to concentrate on an edge of the external conductor, that is, an edge of the second region, on the second side surface. When the stress concentrates on the edge of the second region, a crack may occur in the element body starting from the edge of the second region. The electronic device includes, for example, a circuit board or an other electronic component.

If the crack occurs in the element body, the crack may reach the internal conductor. The crack that has reached the internal conductor in the electronic component may result in deterioration of characteristics.

An object of one aspect of the present disclosure is to provide an electronic component that prevents a crack from occurring in the element body.

An electronic component according to one aspect of the present disclosure includes an element body, an internal conductor, and an external conductor. The element body includes a first side surface and a pair of second side surfaces adjacent to the first side surface and opposing each other. The internal conductor is disposed in the element body and includes an end exposed to the first side surface. The external conductor is disposed on the element body and includes a glass composition and an electrically conductive metal, the glass composition including SiO₂ and Al₂O₃. The external conductor includes: a first region disposed on the first side surface and connected to the end included in the internal conductor; and a second region disposed on at least one of the pair of second side surfaces. The glass composition included in the first region has a total content of SiO₂ and Al₂O₃ of 23 mol % or more. The glass composition included in the second region has a total content of SiO₂ and Al₂O₃ of 5 mol % or more and 20 mol % or less.

The present inventors conducted research and study on an electronic component in which a crack tends to occur in the element body. Consequently, the present inventors have found the following matters.

If the second region tends to separate from the element body when the external force acts on the external conductor, the stress tends not to concentrate on the edge of the second region. That is, a crack tends not to occur in the element body. Therefore, when the external force acts on the external conductor, the second region is required to tends to separate from the element body.

If the first region tends to separate from the element body, the connection between the internal conductor and the first region may be severed. In the electronic component in which the connection between the internal conductor and the first region is severed, the characteristics deteriorate. Therefore, even when the external force acts on the external conductor, the first region is required to tend not to separate from the element body.

Next, the present inventors conducted research and study on an electronic component in which the second region tends to separate from the element body and the first region tends not to separate from the element body when the external force acts on the external conductor. Consequently, the present inventors have found the following facts.

The glass composition included in the external conductor increases bonding strength between the external conductor and the element body. Among oxides included in the glass composition, SiO₂ and Al₂O₃ affect the bonding strength between the external conductor and the element body. A configuration in which the external conductor includes the glass composition with a total content of SiO₂ and Al₂O₃ of 23 mol % or more maintains the bonding strength between the external conductor and the element body. In contrast, a configuration in which the external conductor includes the glass composition with a total content of SiO₂ and Al₂O₃ of 5 mol % or more and 20 mol % or less reduces the bonding strength between the external conductor and the element body.

In the one aspect described above, the glass composition included in the second region has the total content of SiO₂ and Al₂O₃ of 5 mol % or more and 20 mol % or less. Therefore, when the external force acts on the external conductor, the second region tends to separate from the element body. The stress tends not to concentrate on the edge of the second region, on the second side surface. Consequently, the one aspect described above prevents a crack from occurring in the element body.

The glass composition included in the first region has the total content of SiO₂ and Al₂O₃ of 23 mol % or more. Therefore, even when the external force acts on the external conductor, the first region tends not to separate from the element body. Consequently, the one aspect described above prevents deterioration of characteristics.

In the one aspect described above, in the first region, the glass composition may have a content of larger than 5 vol % and less than 25 vol % relative to a total of the glass composition and the electrically conductive metal.

In a configuration in which, in the first region, the glass composition has the content of larger than 5 vol % relative to the total of the glass composition and the electrically conductive metal, this configuration reliably maintains denseness of the first region.

In a configuration in which, in the first region, the glass composition has the content of less than 25 vol % relative to the total of the glass composition and the electrically conductive metal, this configuration can reliably maintain plating adhesion even when forming a plating layer on the first region.

In the one aspect described above, in the second region, the glass composition may have a content of larger than 5 vol % and less than 25 vol % relative to a total of the glass composition and the electrically conductive metal.

In a configuration in which, in the second region, the glass composition has the content of larger than 5 vol % relative to the total of the glass composition and the electrically conductive metal, this configuration reliably maintains denseness of the second region.

In a configuration in which, in the second region, the glass composition has the content of less than 25 vol % relative to the total of the glass composition and the electrically conductive metal, this configuration can reliably maintain plating adhesion even when forming a plating layer on the second region.

In the one aspect described above, in each of the first region and the second region, the glass composition may have a content of larger than 5 vol % and less than 25 vol % relative to a total of the glass composition and the electrically conductive metal.

In a configuration in which, in each of the first region and the second region, the glass composition has the content of larger than 5 vol % relative to the total of the glass composition and the electrically conductive metal, this configuration reliably maintains denseness of each of the first region and the second region.

In a configuration in which, in each of the first region and the second region, the glass composition has the content of less than 25 vol % relative to the total of the glass composition and the electrically conductive metal, this configuration can reliably maintain plating adhesion even when forming a plating layer on the first region and the second region.

In the one aspect described above, a difference in the content of the glass composition between the first region and the second region may be 0 to 7 vol %.

In a configuration in which the difference in the content of the glass composition between the first region and the second region is 0 to 7 vol %, this configuration further reliably maintains denseness of the external conductor.

In the one aspect described above, the second region may be continuously disposed on the first region.

In a configuration in which the second region is continuously disposed on the first region, the first region further tends not to separate from the element body.

In the one aspect described above, the second region may be disposed to entirely cover the first region.

In a configuration in which the second region is disposed to entirely cover the first region, the first region even further tends not to separate from the element body.

In the one aspect described above, a length of the second region disposed on one of the pair of second side surfaces may be larger than a length of the second region disposed on an other of the pair of second side surfaces.

In a configuration in which the length of the second region disposed on the one of the pair of second side surfaces is larger than the length of the second region disposed on the other of the pair of second side surfaces, this configuration can cause directionality in mounting the electronic component. Therefore, in this configuration, the one of the pair of second side surfaces can be reliably arranged to constitute a mounting surface.

In the one aspect described above, the second region may be not disposed on the other of the pair of second side surfaces.

In a configuration in which the second region is not disposed on the other of the pair of second side surfaces, the one of the pair of second side surfaces can be further reliably arranged to constitute the mounting surface.

### BRIEF DESCRIPTION OF THE DRAWINGS

FIG. 1 is a perspective view of a multilayer capacitor according to an example;

FIG. 2 is a view illustrating a cross-sectional configuration of the multilayer capacitor according to the example;

FIG. 3 is a view illustrating a first electrode layer;

FIG. 4 is a schematic view illustrating a configuration of the first electrode layer;

FIG. 5 is a table illustrating test results of samples;

FIG. 6 is a table illustrating test results of samples;

FIG. 7 is a view illustrating a cross-sectional configuration of a multilayer capacitor according to a modified example of the example;

FIG. 8 is a view illustrating a first electrode layer; and

FIG. 9 is a view illustrating a cross-sectional configuration of a multilayer capacitor according to another modified example of the example.

### DETAILED DESCRIPTION

Hereinafter, examples of the present disclosure will be described in detail with reference to the accompanying drawings. In the following description, the same components or components having the same functions are denoted with the same reference numerals and overlapped explanation is omitted.

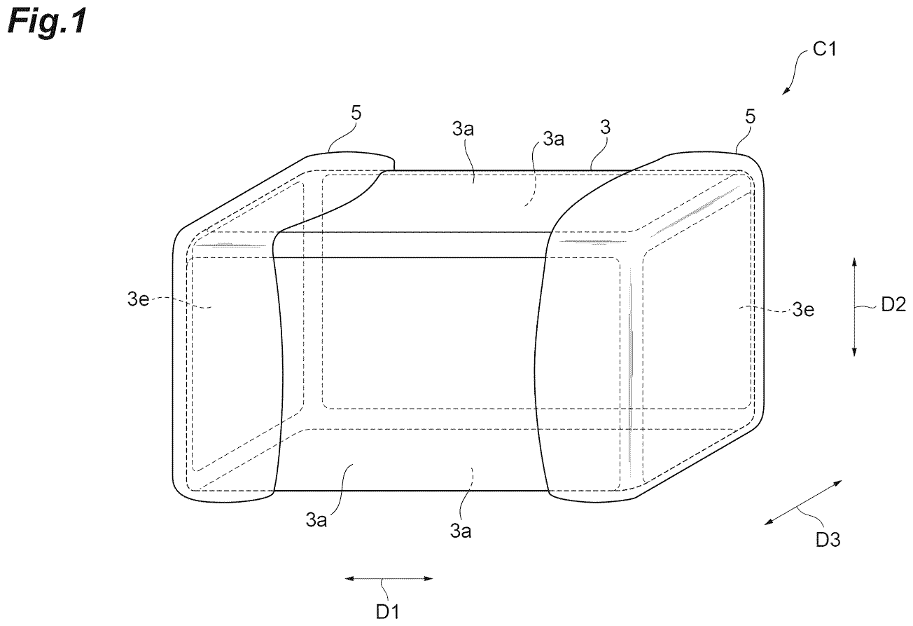

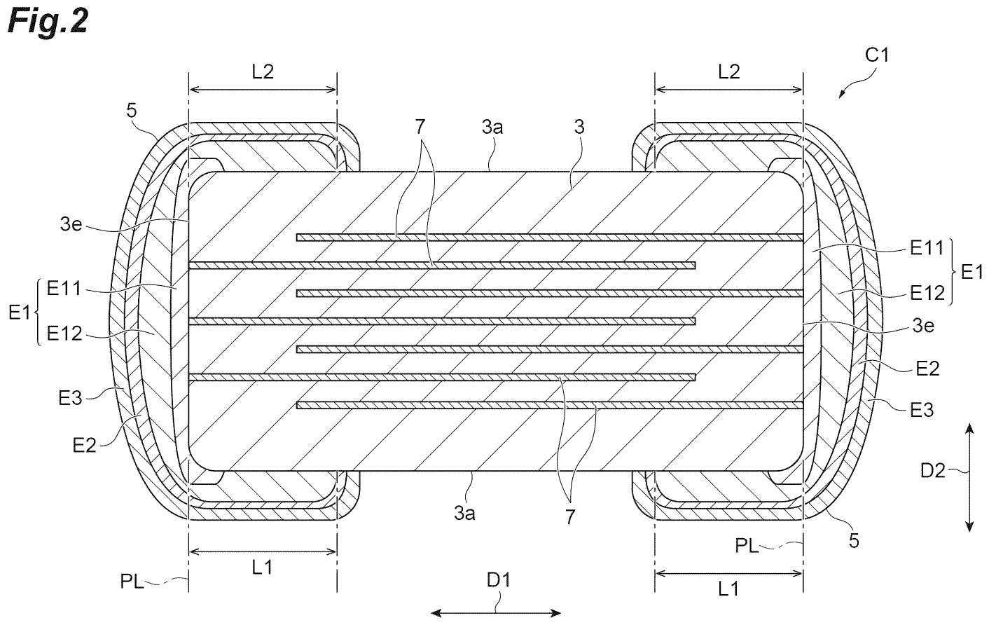

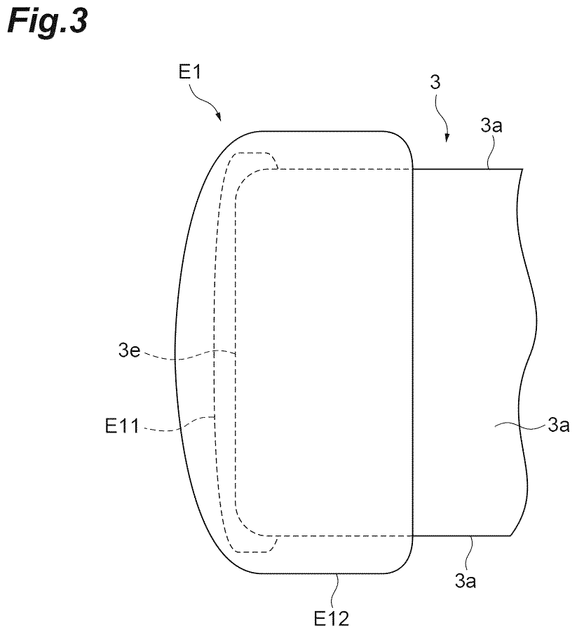

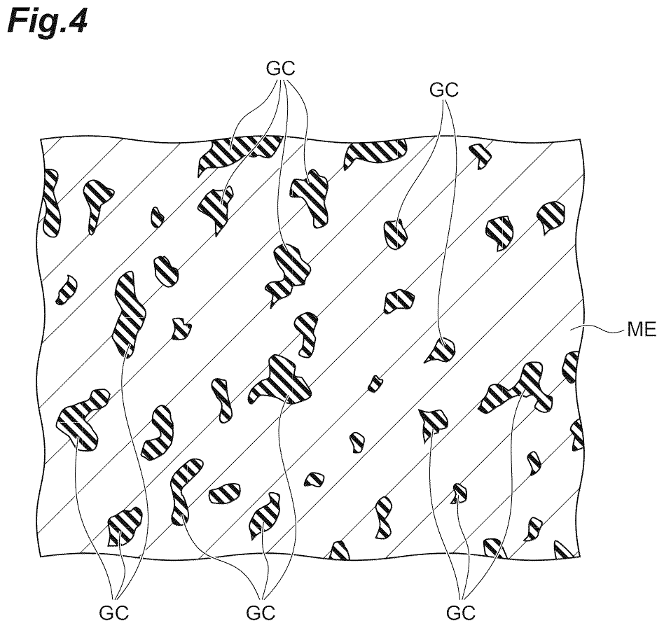

A configuration of a multilayer capacitor C1 according to the example will be described with reference to FIGS. 1 to 4. FIG. 1 is a perspective view of a multilayer capacitor according to the example. FIG. 2 is a view illustrating a cross-sectional configuration of the multilayer capacitor according to the example. FIG. 3 is a view illustrating a first electrode layer. FIG. 4 is a schematic view illustrating a configuration of the first electrode layer.

An electronic component includes, for example, the multilayer capacitor C1.

As illustrated in FIG. 1, the multilayer capacitor C1 includes an element body 3 of a rectangular parallelepiped shape and a plurality of external electrodes 5. For example, the multilayer capacitor C1 includes a pair of external electrodes 5. The pair of external electrodes 5 are disposed on an outer surface of the element body 3. The pair of external electrodes 5 are separated from each other. The rectangular parallelepiped shape includes, for example, a rectangular parallelepiped shape in which corners and ridges are chamfered, or a rectangular parallelepiped shape in which the corners and ridges are rounded.

The element body 3 includes four side surfaces 3a and a pair of end surfaces 3e opposing each other. The four side surfaces 3a and the pair of end surfaces 3e each have a substantially rectangular shape. The four side surfaces 3a include a first pair of side surfaces 3a opposing each other and a second pair of side surfaces 3a opposing each other. A direction in which the first pair of side surfaces 3a oppose each other includes a direction D2. A direction in which the second pair of side surfaces 3a oppose each other includes a direction D3. A direction in which the pair of end surfaces 3e oppose each other includes a direction D1.

The multilayer capacitor C1 is solder-mounted on an electronic device, for example. The electronic device includes, for example, a circuit board or another electronic component. In the multilayer capacitor C1, for example, one of the four side surfaces 3a opposes the electronic device. The one of the four side surfaces 3a is arranged to constitute a mounting surface. The one of the four side surfaces 3a includes the mounting surface.

The side surface 3e may include a first side surface, and the first pair of side surfaces 3a or the second pair of side surfaces 3a may include a pair of second side surfaces. Each of the pair of side surfaces 3e may define an end surface, for example.

The direction D2 includes a direction perpendicular to the first pair of side surfaces 3a, and is perpendicular to the direction D3. The direction D1 includes a direction parallel to the four side surfaces 3a, and is perpendicular to the direction D2 and the direction D3. The direction D3 includes a direction perpendicular to the second pair of side surfaces 3a, and the direction D1 includes a direction perpendicular to the end surfaces 3e. For example, a length of the element body 3 in the direction D1 is larger than a length of the element body 3 in the direction D2 and larger than a length of the element body 3 in the direction D3. The direction D1 includes a longitudinal direction of the element body 3. The length of the element body 3 in the direction D2 and the length of the element body 3 in the direction D3 may be equal to each other. The length of the element body 3 in the direction D2 and the length of the element body 3 in the direction D3 may be different from each other.

The length of the element body 3 in the direction D2 defines, for example, a height of the element body 3. The length of the element body 3 in the direction D3 defines, for example, a width of the element body 3. The length of the element body 3 in the direction D1 defines, for example, a longitudinal length of the element body 3. For example, the height of the element body 3 is 0.1 to 3.2 mm, the width of the element body 3 is 0.1 to 6.3 mm, and the longitudinal length of the element body 3 is 0.2 to 7.5 mm. For example, the height of the element body 3 is 1.6 mm, the width of the element body 3 is 1.6 mm, and the longitudinal length of the element body 3 is 3.2 mm.

The first pair of side surfaces 3a extend in the direction D3 to couple the second pair of side surfaces 3a to each other. The first pair of side surfaces 3a also extend in the direction D1. The second pair of side surfaces 3a extend in the direction D2 to couple the first pair of side surfaces 3a to each other. The second pair of side surfaces 3a also extend in the direction D1. The pair of end surfaces 3e extend in the direction D2 to couple the first pair of side surfaces 3a to each other. The pair of end surfaces 3e also extend in the direction D3 to couple the second pair of side surfaces 3a to each other.

The element body 3 includes a ridge portion between the end surface 3e and the side surface 3a and a ridge portion between one of the first pair of side surfaces 3a and one of the second pair of side surfaces 3a. For example, the ridge portions are rounded to be curved. For example, the element body 3 is subjected to what is called a round chamfering process. The end surface 3e and the side surface 3a are indirectly adjacent to each other with the ridge portion between the end surface 3e and the side surface 3a. The one of the first pair of side surfaces 3a and the one of the second pair of side surfaces 3a are indirectly adjacent to each other with the ridge portion between the one of the first pair of side surfaces 3a and the one of the second pair of side surfaces 3a.

The element body 3 is configured through laminating a plurality of dielectric layers in the direction D2. The element body 3 includes a plurality of laminated dielectric layers. In the element body 3, a lamination direction of the plurality of dielectric layers coincides with the direction D2. Each dielectric layer includes, for example, a sintered body of a ceramic green sheet containing a dielectric material. Examples of the dielectric material include dielectric ceramics. Examples of the dielectric ceramics include BaTiO₃-based, Ba(Ti, Zr)O₃-based, or (Ba, Ca)TiO₃-based dielectric ceramics. In the actual element body 3, each of the dielectric layers is integrated to such an extent that a boundary between the dielectric layers cannot be visually recognized. The element body 3 includes a ceramic element body.

As illustrated in FIG. 2, the multilayer capacitor C1 includes a plurality of internal electrodes 7. Each of the internal electrodes 7 includes an internal conductor disposed in the element body 3. Each of the internal electrodes 7 is made of an electrically conductive material that is commonly used as an internal conductor of a multilayer electronic component. The electrically conductive material includes, for example, a base metal. The electrically conductive material includes, for example, nickel (Ni) or copper (Cu). Each of the internal electrodes 7 is configured as a sintered body of electrically conductive paste containing the electrically conductive material described above. For example, the internal electrodes 7 include nickel.

The plurality of internal electrodes 7 are disposed in different positions (layers) in the direction D2. The plurality of internal electrodes 7 are disposed in the element body 3 to oppose each other in the direction D2 with an interval therebetween. The internal electrodes 7 adjacent to each other in the direction D2 have different polarities from each other. One end of the internal electrode 7 is exposed to a corresponding end surface 3e of the pair of end surfaces 3e. The internal electrode 7 includes one end exposed to the corresponding end surface 3e. The plurality of internal electrodes 7 include an internal electrode 7 exposed to one end surface 3e of the pair of end surfaces 3e and an internal electrode 7 exposed to the other end surface 3e of the pair of end surfaces 3e. The internal electrodes 7 exposed to the one end surface 3e and the internal electrodes 7 exposed to the other end surface 3e are alternately disposed in the direction D2. The plurality of internal electrodes 7 are disposed in the element body 3 to be distributed in the direction D2. Each of the plurality of internal electrodes 7 is positioned in a plane substantially parallel to the first pair of side surfaces 3a. A direction in which the internal electrodes 7 oppose each other is perpendicular to a direction parallel to the first pair of side surfaces 3a.

In a configuration in which the lamination direction of the plurality of dielectric layers includes the direction D3, the plurality of internal electrodes 7 are disposed in different positions (layers) in the direction D3. In a configuration in which the lamination direction of the plurality of dielectric layers includes the direction D3, the internal electrodes 7 exposed to the one end surface 3e and the internal electrodes 7 exposed to the other end surface 3e are alternately disposed in the direction D3. Each of the plurality of internal electrodes 7 is positioned in a plane substantially parallel to the second pair of side surfaces 3a. The internal electrodes 7 oppose each other in the direction D3.

As illustrated in FIG. 1, the pair of external electrodes 5 are disposed at both ends of the element body 3 in the first direction D1. Each external electrode 5 is disposed on a corresponding end surface 3e of the pair of end surfaces 3e. For example, each external electrode 5 is disposed on the four side surfaces 3a and the one end surface 3e.

Each external electrode 5 is formed on five surfaces of the four side surfaces 3a and the end surface 3e as well as the above-described ridge portions. Each external electrode 5 entirely covers the one end of a corresponding internal electrode 7 of the plurality of internal electrodes 7. Each external electrode 5 is directly connected to the corresponding internal electrode 7. Each external electrode 5 is electrically connected to the corresponding internal electrode 7.

As illustrated in FIG. 2, the external electrode 5 includes a first electrode layer E1, a second electrode layer E2, and a third electrode layer E3. The first electrode layer E1 is disposed on the element body 3. As illustrated in FIG. 3, the first electrode layer E1 is disposed, for example, on the four side surfaces 3a and on the side surface 3e. The first electrode layer E1 includes an external conductor. The second electrode layer E2 is disposed on the first electrode layer E1. The third electrode layer E3 is disposed on the second electrode layer E2.

The first electrode layer E1 includes, for example, a sintered metal layer. As illustrated in FIG. 4, the first electrode layer E1 includes a glass composition GC and an electrically conductive metal ME. The glass composition GC includes, for example, boron oxide (B₂O₃), silicon oxide (SiO₂), aluminum oxide (Al₂O₃), and at least one of strontium oxide (SrO) or barium oxide (BaO). The glass composition GC may include a metal oxide other than boron oxide, silicon oxide, aluminum oxide, strontium oxide, and barium oxide. The metal oxide other than barium oxide includes, for example, at least one of zinc oxide (ZnO) or calcium oxide (CaO). The electrically conductive metal ME includes, for example, copper (Cu). The electrically conductive metal ME may include nickel (Ni) instead of copper. The first electrode layer E1 may include a plurality of voids.

The second electrode layer E2 includes, for example, a metal plating layer. The second electrode layer E2 may include a nickel plating layer. The second electrode layer E2 may include nickel. The nickel plating layer tends to have better solder leach resistance than the electrically conductive metal ME included in the first electrode layer E1. The second electrode layer E2 covers the first electrode layer E1.

The third electrode layer E3 includes, for example, a metal plating layer. The third electrode layer E3 may include a solder plating layer. The solder plating layer may include a tin (Sn) plating layer. The third electrode layer E3 may include tin. The third electrode layer E3 may be a tin-silver alloy (Sn—Ag) plating layer, a tin-bismuth alloy (Sn—Bi) plating layer, or a tin-copper alloy (Sn—Cu) plating layer. The third electrode layer E3 covers the second electrode layer E2.

As illustrated in FIGS. 2 and 3, the first electrode layer E1 includes a conductor region E11 disposed on the side surface 3e and a conductor region E12 disposed on the side surface 3a. The first electrode layer E1 includes, for example, only the conductor region E11 and conductor region E12. In a configuration in which the first electrode-layer E1 includes only the conductor region E11 and conductor region E12, for example, the conductor region E11 is integrated with the conductor region E12. For example, the conductor region E11 may include a first region, and the conductor region E12 may include a second region.

The conductor region E11 is formed on the side surface 3e. The conductor region E11 covers the side surface 3e. The conductor region E11 directly covers the side surface 3e. The conductor region E11 is in direct contact with the side surface 3e. The conductor region E11 is directly connected to the one end of the corresponding internal electrode 7. The conductor region E11 is physically and electrically connected to the one end of the corresponding internal electrode 7. The conductor region E11 is formed, for example, on the ridge portion between the side surface 3e and the side surface 3a. The conductor region E11 may not be formed on the ridge portion between the side surface 3e and the side surface 3a. The side surface 3a is not covered with the conductor region E11, and is exposed from the conductor region E11.

The conductor region E12 is formed on the side surface 3a. The conductor region E12 covers a partial region of the side surface 3a. The conductor region E12 directly covers the partial region of the side surface 3a. The conductor region E12 is in direct contact with the side surface 3a. The partial region covered by the conductor region E12 is positioned closer to the side surface 3e. The side surface 3a is exposed from the conductor region E12 at the remaining region excluding the partial region covered by the conductor region E12. The conductor region E12 is formed on, for example, the four side surfaces 3a. The conductor region E12 is formed, for example, on the ridge portion between the side surfaces 3a adjacent to each other. In a configuration in which the conductor region E11 is not formed on the ridge portion between the side surface 3e and the side surface 3a, the conductor region E12 may be formed on the ridge portion between the side surface 3e and the side surface 3a.

The conductor regions E11 and E12 are, for example, in direct contact with each other. The conductor region E12 is continuously disposed on the conductor region E11. The conductor region E12 is disposed to cover at least a part of the conductor region E11. The conductor region E12 is disposed, for example, to entirely cover the conductor region E11. The conductor region E12 is positioned outside the conductor region E11. The conductor region E12 is positioned, for example, at the outermost part of the first electrode layer E1. The conductor region E11 includes a surface in contact with the element body 3 and a surface in contact with the conductor region E12. The conductor region E12 includes a surface in contact with the conductor region E11 and a surface in contact with the second electrode layer E2. The first electrode layer E1 includes at least the conductor region E12 on the side surface 3a. The first electrode layer E1 includes at least the conductor region E11 and the conductor region E12 on the side surface 3e.

A length L1 of the conductor region E12 disposed on the side surface 3a arranged to constitute the mounting surface is, for example, substantially equal to a length L2 of the conductor region E12 disposed on the side surface 3a opposing the side surface 3a arranged to constitute the mounting surface. The lengths L1 and L2 are, for example, lengths of the conductor region E12 from a reference plane PL. For example, the lengths L1 and L2 are maximum lengths from the reference plane PL in a direction perpendicular to the reference plane PL. The reference plane PL includes the side surface 3e.

The conductor region E12 may not cover the conductor region E11. In a configuration in which the conductor region E12 does not cover the conductor region E11, for example, an end edge that is included in the conductor region E11 and is in contact with the element body 3 may be in contact with an end edge that is included in the conductor region E12 and is in contact with the element body 3. The conductor region E11 and the conductor region E12 may be separated from each other on the surface of the element body 3. In a configuration in which the conductor region E11 and the conductor region E12 are separated from each other, the first electrode layer E1 may include another conductor region in contact with the conductor region E11 and the conductor region E12.

As described above, the first electrode layer E1 includes the glass composition GC and the electrically conductive metal ME. Therefore, although not illustrated, the conductor region E11 and the conductor region E12 included in the first electrode layer E1 also include the glass composition GC and the electrically conductive metal ME.

The glass composition GC included in the conductor region E11 has a total content of SiO₂ and Al₂O₃ of 23 mol % or more. The glass composition GC included in the conductor region E11 includes, for example,
30 to 40 mol % of at least one of strontium oxide or barium oxide,
15 to 30 mol % of boron oxide,
10 to 20 mol % of aluminum oxide,
10 to 25 mol % of silicon oxide, and
10 to 15 mol % of other metal oxide. The other metal oxide includes, for example, zinc oxide.

The glass composition GC included in the conductor region E12 has a total content of SiO₂ and Al₂O₃ of 5 mol % or more and 20 mol % or less. The glass composition GC included in the conductor region E12 includes, for example,
25 to 35 mol % of at least one of strontium oxide or barium oxide,
20 to 40 mol % of boron oxide,
2 to 9 mol % of aluminum oxide,
3 to 16 mol % of silicon oxide, and
25 to 35 mol % of other metal oxide. The other metal oxide includes, for example, zinc oxide and calcium oxide.

The glass composition GC included in the conductor region E11 has, for example, a content of larger than 5 vol % and less than 25 vol % relative to a total of the glass composition GC and the electrically conductive metal ME. The glass composition GC included in the conductor region E12 has, for example, a content of larger than 5 vol % and less than 25 vol % relative to a total of the glass composition GC and the electrically conductive metal ME. A difference in the content of the glass composition GC between the conductor region E11 and the conductor region E12 is, for example, 0 to 7 vol %.

The content of the glass composition GC can be obtained, for example, as follows.

A cross-sectional photograph of the external electrode 5 including the conductor region E11 and the conductor region E12 is acquired. The cross-sectional photograph is, for example, a photograph of a cross-section of the external electrode 5 when cut along a plane perpendicular to the side surface 3e. The cross-sectional photograph is, for example, a scanning electron microscope (SEM) photograph. Image processing of the acquired cross-sectional photograph is performed using software. Based on the result of this image processing, a boundary of the glass composition GC and a boundary of the electrically conductive metal ME are determined, and a total area of the glass composition GC and a total area of the electrically conductive metals ME in the cross-sectional photograph are obtained in each of the conductor region E11 and the conductor region E12. In each of the conductor region E11 and the conductor region E12, the total area of the glass composition GC is divided by the sum of the total area of the glass composition GC and the total area of the electrically conductive metals ME, and the resulting value is expressed as a percentage. This value may be represented as the content of the glass composition GC, using the unit of “vol %”.

Next, the content of SiO₂ and Al₂O₃ in the glass composition included in each of the conductor regions E11 and E12 will be described.

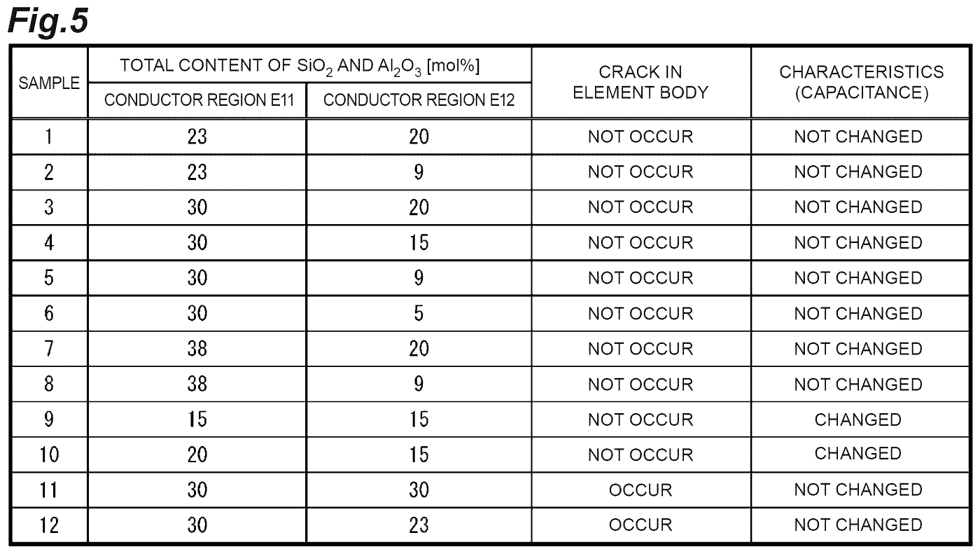

The present inventors conducted the following test to clarify the content of SiO₂ and Al₂O₃. In this test, the present inventors prepared samples S1 to S12 having different contents of SiO₂ and Al₂O₃, and confirmed occurrence of a crack and change in characteristics in each of the samples S1 to S12. The results are illustrated in FIG. 5. FIG. 5 is a table illustrating test results of samples.

Each of the samples S1 to S12 is a lot including a plurality of specimens. Each specimen of the samples S1 to S12 has the same configuration as the multilayer capacitor C1 illustrated in FIGS. 1 to 4 except that the composition ratio of the glass composition is different. In the specimen of each of the samples S1 to S12, the height of the element body is 1.6 mm, the width of the element body is 1.6 mm, and the length of the element body is 3.2 mm. The capacitance of each specimen is 10 μF. In the specimen of each of the samples S1 to S12, the glass composition has a content of 15 vol % relative to the total of the glass composition and the electrically conductive metal in each of the conductor region E11 and the conductor region E12.

The composition of the glass composition included in each of the conductor region E11 and the conductor region E12 in each specimen of the sample S1 is as follows.

The glass composition included in the conductor region E11 includes:
39 mol % of strontium oxide;
25 mol % of boron oxide;
13 mol % of aluminum oxide;
10 mol % of silicon oxide; and
13 mol % of zinc oxide. The glass composition included in the conductor region E11 has the total content of SiO₂ and Al₂O₃ of 23 mol %.

The glass composition included in the conductor region E12 includes:
30 mol % of barium oxide;
25 mol % of boron oxide;
6 mol % of aluminum oxide;
14 mol % of silicon oxide; and
25 mol % of zinc oxide and calcium oxide. The glass composition included in the conductor region E12 has the total content of SiO₂ and Al₂O₃ of 20 mol %.

The composition of the glass composition included in each of the conductor region E11 and the conductor region E12 in each specimen of the sample S2 is as follows.

The glass composition included in the conductor region E11 includes:
39 mol % of strontium oxide;
25 mol % of boron oxide;
13 mol % of aluminum oxide;
10 mol % of silicon oxide; and
13 mol % of zinc oxide. The glass composition included in the conductor region E11 has the total content of SiO₂ and Al₂O₃ of 23 mol %.

The glass composition included in the conductor region E12 includes:
29 mol % of barium oxide;
24 mol % of boron oxide;
3 mol % of aluminum oxide;
6 mol % of silicon oxide; and
38 mol % of zinc oxide and calcium oxide. The glass composition included in the conductor region E12 has the total content of SiO₂ and Al₂O₃ of 9 mol %.

The composition of the glass composition included in each of the conductor region E11 and the conductor region E12 in each specimen of the sample S3 is as follows.

The glass composition included in the conductor region E11 includes:
36 mol % of strontium oxide;
21 mol % of boron oxide;
15 mol % of aluminum oxide;
15 mol % of silicon oxide; and
13 mol % of zinc oxide. The glass composition included in the conductor region E11 has the total content of SiO₂ and Al₂O₃ of 30 mol %.

The glass composition included in the conductor region E12 includes:
30 mol % of barium oxide;
25 mol % of boron oxide;
6 mol % of aluminum oxide;
14 mol % of silicon oxide; and
25 mol % of zinc oxide and calcium oxide. The glass composition included in the conductor region E12 has the total content of SiO₂ and Al₂O₃ of 20 mol %.

The composition of the glass composition included in each of the conductor region E11 and the conductor region E12 in each specimen of the sample S4 is as follows.

The glass composition included in the conductor region E11 includes:
36 mol % of strontium oxide;
21 mol % of boron oxide;
15 mol % of aluminum oxide;
15 mol % of silicon oxide; and
13 mol % of zinc oxide. The glass composition included in the conductor region E11 has the total content of SiO₂ and Al₂O₃ of 30 mol %.

The glass composition included in the conductor region E12 includes:
30 mol % of barium oxide;
25 mol % of boron oxide;
mol % of aluminum oxide;
mol % of silicon oxide; and
30 mol % of zinc oxide and calcium oxide. The glass composition included in the conductor region E12 has the total content of SiO₂ and Al₂O₃ of 15 mol %.

The composition of the glass composition included in each of the conductor region E11 and the conductor region E12 in each specimen of the sample S5 is as follows.

The glass composition included in the conductor region E11 includes:
36 mol % of strontium oxide;
21 mol % of boron oxide;
mol % of aluminum oxide;
15 mol % of silicon oxide; and
13 mol % of zinc oxide. The glass composition included in the conductor region E11 has the total content of SiO₂ and Al₂O₃ of 30 mol %.

The glass composition included in the conductor region E12 includes:
29 mol % of barium oxide;
24 mol % of boron oxide;
3 mol % of aluminum oxide;
6 mol % of silicon oxide; and
38 mol % of zinc oxide and calcium oxide. The glass composition included in the conductor region E12 has the total content of SiO₂ and Al₂O₃ of 9 mol %.

The composition of the glass composition included in each of the conductor region E11 and the conductor region E12 in each specimen of the sample S6 is as follows.

The glass composition included in the conductor region E11 includes:
36 mol % of strontium oxide;
21 mol % of boron oxide;
15 mol % of aluminum oxide;
15 mol % of silicon oxide; and
13 mol % of zinc oxide. The glass composition included in the conductor region E11 has the total content of SiO₂ and Al₂O₃ of 30 mol %.

The glass composition included in the conductor region E12 includes:
34 mol % of barium oxide;
36 mol % of boron oxide;
2 mol % of aluminum oxide;
3 mol % of silicon oxide; and
25 mol % of zinc oxide and calcium oxide. The glass composition included in the conductor region E12 has the total content of SiO₂ and Al₂O₃ of 5 mol %.

The composition of the glass composition included in each of the conductor region E11 and the conductor region E12 in each specimen of the sample S7 is as follows.

The glass composition included in the conductor region E11 includes:
37 mol % of strontium oxide;
15 mol % of boron oxide;
15 mol % of aluminum oxide;
23 mol % of silicon oxide; and
10 mol % of zinc oxide. The glass composition included in the conductor region E11 has the total content of SiO₂ and Al₂O₃ of 38 mol %.

The glass composition included in the conductor region E12 includes:
30 mol % of barium oxide;
25 mol % of boron oxide;
6 mol % of aluminum oxide;
14 mol % of silicon oxide; and
25 mol % of zinc oxide and calcium oxide. The glass composition included in the conductor region E12 has the total content of SiO₂ and Al₂O₃ of 20 mol %.

The composition of the glass composition included in each of the conductor region E11 and the conductor region E12 in each specimen of the sample S8 is as follows.

The glass composition included in the conductor region E11 includes:
37 mol % of strontium oxide;
15 mol % of boron oxide;
15 mol % of aluminum oxide;
23 mol % of silicon oxide; and
10 mol % of zinc oxide. The glass composition included in the conductor region E11 has the total content of SiO₂ and Al₂O₃ of 38 mol %.

The glass composition included in the conductor region E12 includes:
29 mol % of barium oxide;
24 mol % of boron oxide;
3 mol % of aluminum oxide;
6 mol % of silicon oxide; and
38 mol % of zinc oxide and calcium oxide. The glass composition included in the conductor region E12 has the total content of SiO₂ and Al₂O₃ of 9 mol %.

The composition of the glass composition included in each of the conductor region E11 and the conductor region E12 in each specimen of the sample S9 is as follows.

The glass composition included in the conductor region E11 includes:
30 mol % of strontium oxide;
25 mol % of boron oxide;
5 mol % of aluminum oxide;
10 mol % of silicon oxide; and
30 mol % of zinc oxide. The glass composition included in the conductor region E11 has the total content of SiO₂ and Al₂O₃ of 15 mol %.

The glass composition included in the conductor region E12 includes:
30 mol % of barium oxide;
25 mol % of boron oxide;
5 mol % of aluminum oxide;
10 mol % of silicon oxide; and
30 mol % of zinc oxide and calcium oxide. The glass composition included in the conductor region E12 has the total content of SiO₂ and Al₂O₃ of 15 mol %.

The composition of the glass composition included in each of the conductor region E11 and the conductor region E12 in each specimen of the sample S10 is as follows.

The glass composition included in the conductor region E11 includes:
30 mol % of strontium oxide;
25 mol % of boron oxide;
6 mol % of aluminum oxide;
14 mol % of silicon oxide; and
25 mol % of zinc oxide. The glass composition included in the conductor region E11 has the total content of SiO₂ and Al₂O₃ of 20 mol %.

The glass composition included in the conductor region E12 includes:
30 mol % of barium oxide;
25 mol % of boron oxide;
5 mol % of aluminum oxide;
10 mol % of silicon oxide; and
30 mol % of zinc oxide and calcium oxide. The glass composition included in the conductor region E12 has the total content of SiO₂ and Al₂O₃ of 15 mol %.

The composition of the glass composition included in each of the conductor region E11 and the conductor region E12 in each specimen of the sample S11 is as follows.

The glass composition included in the conductor region E11 includes:
36 mol % of strontium oxide;
21 mol % of boron oxide;
15 mol % of aluminum oxide;
15 mol % of silicon oxide; and
13 mol % of zinc oxide. The glass composition included in the conductor region E11 has the total content of SiO₂ and Al₂O₃ of 30 mol %.

The glass composition included in the conductor region E12 includes:
36 mol % of strontium oxide;
21 mol % of boron oxide;
15 mol % of aluminum oxide;
15 mol % of silicon oxide; and
13 mol % of zinc oxide and calcium oxide. The glass composition included in the conductor region E12 has the total content of SiO₂ and Al₂O₃ of 30 mol %.

The composition of the glass composition included in each of the conductor region E11 and the conductor region E12 in each specimen of the sample S12 is as follows.

The glass composition included in the conductor region E11 includes:
36 mol % of strontium oxide;
21 mol % of boron oxide;
15 mol % of aluminum oxide;
15 mol % of silicon oxide; and
13 mol % of zinc oxide. The glass composition included in the conductor region E11 has the total content of SiO₂ and Al₂O₃ of 30 mol %.

The glass composition included in the conductor region E12 includes:
39 mol % of strontium oxide;
25 mol % of boron oxide;
13 mol % of aluminum oxide;
10 mol % of silicon oxide; and
13 mol % of zinc oxide and calcium oxide. The glass composition included in the conductor region E12 has the total content of SiO₂ and Al₂O₃ of 23 mol %.

The occurrence of the crack is confirmed as follows.

For each of the samples S1 to S12, 10 specimens are selected, and a flexural strength test is conducted on each specimen. In the flexural strength test, initially, the specimen is solder-mounted on a center portion of a test substrate. The test substrate includes a glass epoxy substrate. The size of the test substrate is 100 mm×40 mm, and the thickness of the test substrate is 1.0 mm. Next, the test substrate with the specimen solder-mounted is placed on two supports arranged in parallel with a spacing of 90 mm. The test substrate is placed such that a surface on which the specimen is solder-mounted faces downward. Subsequently, flexural stress is applied to the center portion of the test substrate from the backside of the surface on which the specimen is solder-mounted, so that the flexural amount of the test substrate reaches a desired value. In this test, the flexural amount of the test substrate is 15 mm.

After the flexural strength test, the specimen in the state of being solder-mounted on the test substrate is embedded in a resin, and the specimen in the state of being embedded in the resin is polished together with the solder and the test substrate. Whether a crack is generated on the polished surface of the element body of the specimen is confirmed using an optical microscope.

The change in the characteristics is confirmed as follows.

For each of the samples S1 to S12, 10 specimens are selected, and an electrostatic capacitance of each specimen is measured. A flexural strength test is conducted on the specimen whose capacitance has been measured. After the flexural strength test, the electrostatic capacitance of the specimen is measured again. The rate of change in the electrostatic capacitance before and after conducting the flexural strength test is obtained based on the measurement results of the electrostatic capacitance. For a specimen having a rate of change in the electrostatic capacitance of less than 12.5%, a situation of change in characteristics is determined as “Good”. For a specimen having a rate of change in the electrostatic capacitance of 12.5% or more, a situation of change in characteristics is determined as “Fail”. A multilayer capacitor having a rate of change in the electrostatic capacitance of less than 12.5% tends to be suitable for practical use.

As a result of the above-described test, as illustrated in FIG. 5, in the samples S1 to S10, the occurrence of the crack was not confirmed in each specimen. In contrast, in the sample S11, the occurrence of the crack was confirmed in four or more specimens. In the sample S12, although the number of specimens in which the crack occurred was three or less, the occurrence of the crack was confirmed in the specimens.

As a result of the above-described test, as illustrated in FIG. 5, in the samples S1 to S8 and S11 to S12, the change in the characteristics was not confirmed in each sample. In contrast, in the sample S9, the change in the characteristics was confirmed in four or more specimens. In the sample S10, although the number of the samples in which the characteristics were changed was three or less, the change in the characteristics were confirmed in the specimens.

Next, the content of the glass composition in each of the conductor regions E11 and E12 will be described.

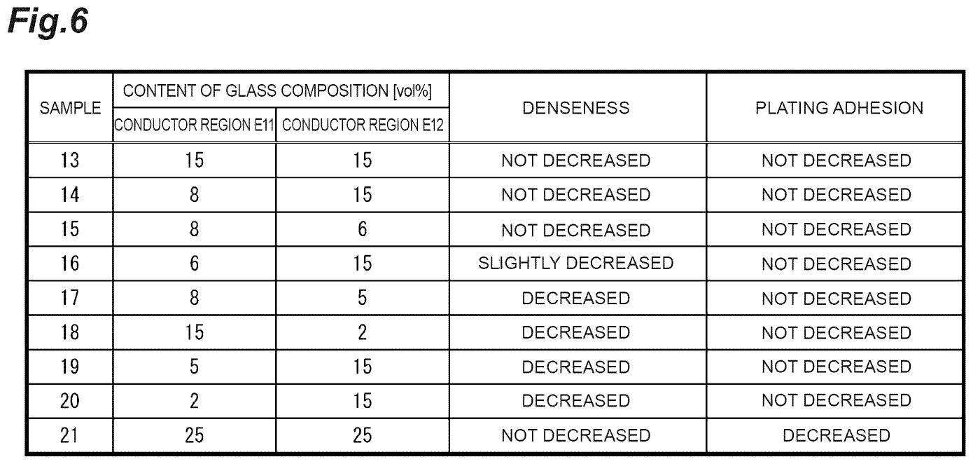

The present inventors conducted the following test to clarify the content of the glass composition in each of the conductor regions E11 and E12. In this test, the present inventors prepared samples S13 to S21 having different contents of the glass composition, and confirmed denseness of the first electrode layer E1 and plating adhesion to the first electrode layer E1 in each of the samples S13 to S21. The results are illustrated in FIG. 6. FIG. 6 is a table illustrating test results of samples.

Each of the samples S13 to S21 is a lot including a plurality of specimens. Each specimen of the samples S13 to S21 has the same configuration as the multilayer capacitor C1 illustrated in FIGS. 1 to 4 except that the composition ratio of the glass composition is different. In the specimen of each of the samples S13 to S21, the height of the element body is 1.6 mm, the width of the element body is 1.6 mm, and the length of the element body is 3.2 mm. The capacitance of each specimen is 10 μF.

In the specimens of each of the sample S13 to S21, the glass composition included in the conductor region E11 includes:
36 mol % of strontium oxide;
21 mol % of boron oxide;
15 mol % of aluminum oxide;
15 mol % of silicon oxide; and
13 mol % of zinc oxide. The glass composition included in the conductor region E11 has the total content of SiO₂ and Al₂O₃ of 30 mol %.

In the specimens of each of the sample S13 to S21, the glass composition included in the conductor region E12 includes:
30 mol % of barium oxide;
25 mol % of boron oxide;
5 mol % of aluminum oxide;
10 mol % of silicon oxide; and
30 mol % of zinc oxide and calcium oxide. The glass composition included in the conductor region E12 has the total content of SiO₂ and Al₂O₃ of 15 mol %.

In each of the specimens of the sample S13, in the conductor region E11, the glass composition has the content of 15 vol % relative to the total of the glass composition and the electrically conductive metal. In the conductor region E12, the glass composition has the content of 15 vol % with respect to the sum of the glass composition and the electrically conductive metal.

In each of the specimens of the sample S14, in the conductor region E11, the glass composition has the content of 8 vol % relative to the total of the glass composition and the electrically conductive metal. In the conductor region E12, the glass composition has the content of 15 vol % with respect to the sum of the glass composition and the electrically conductive metal.

In each of the specimens of the sample S15, in the conductor region E11, the glass composition has the content of 8 vol % relative to the total of the glass composition and the electrically conductive metal. In the conductor region E12, the glass composition has the content of 6 vol % with respect to the sum of the glass composition and the electrically conductive metal.

In each of the specimens of the sample S16, in the conductor region E11, the glass composition has the content of 6 vol % relative to the total of the glass composition and the electrically conductive metal. In the conductor region E12, the glass composition has the content of 15 vol % with respect to the sum of the glass composition and the electrically conductive metal.

In each of the specimens of the sample S17, in the conductor region E11, the glass composition has the content of 8 vol % relative to the total of the glass composition and the electrically conductive metal. In the conductor region E12, the glass composition has the content of 5 vol % with respect to the sum of the glass composition and the electrically conductive metal.

In each of the specimens of the sample S18, in the conductor region E11, the glass composition has the content of 15 vol % relative to the total of the glass composition and the electrically conductive metal. In the conductor region E12, the glass composition has the content of 2 vol % with respect to the sum of the glass composition and the electrically conductive metal.

In each of the specimens of the sample S19, in the conductor region E11, the glass composition has the content of 5 vol % relative to the total of the glass composition and the electrically conductive metal. In the conductor region E12, the glass composition has the content of 15 vol % with respect to the sum of the glass composition and the electrically conductive metal.

In each of the specimens of the sample S20, in the conductor region E11, the glass composition has the content of 2 vol % relative to the total of the glass composition and the electrically conductive metal. In the conductor region E12, the glass composition has the content of 15 vol % with respect to the sum of the glass composition and the electrically conductive metal.

In each of the specimens of the sample S21, in the conductor region E11, the glass composition has the content of 25 vol % relative to the total of the glass composition and the electrically conductive metal. In the conductor region E12, the glass composition has the content of 25 vol % with respect to the sum of the glass composition and the electrically conductive metal.

The denseness is confirmed as follows.

For each of the samples S13 to S21, 10 specimens are selected. Each specimen is cut, and a cross-sectional photograph of the first electrode layer E1 is acquired. The cross-sectional photograph is, for example, a photograph of a cross-section of the first electrode layer E1 when cut along a plane perpendicular to the side surfaces 3a and 3e. Image processing of the acquired cross-sectional photograph is performed using software. Based on the result of this image processing, boundaries of voids included in the first electrode layer E1 is determined, and a total area of the voids included in the conductor region E11 and a total area of the voids included in the conductor region E12 are obtained. The total area of the voids included in the conductor region E11 is divided by an area of the conductor region E11, and the resulting value represents an existence ratio of the voids in the conductor region E11. The total area of the voids included in the conductor region E12 is divided by an area of the conductor region E12, and the resulting value represents an existence ratio of the voids in the conductor region E12. A configuration in which the value of the existence ratio expressed as a percentage is 3% or less is determined to have high denseness. A configuration in which the value of the existence ratio expressed as a percentage is larger than 3% is determined to have low denseness. A configuration in which the existence ratio is 3% or less tends to increase reliability, for example.

The plating adhesion is confirmed as follows.

For each of the samples S13 to S21, 10 specimens are selected, and a surface of the external electrode 5 is observed for each specimen. A specimen in which the second electrode layer E2 (third electrode layer E3) is formed in a range of 99% or more of the surface area of the external electrodes 5 is determined to have high plating adhesion. A specimen in which the second electrode layer E2 (third electrode layer E3) is formed in a range of less than 99% of the surface area of the external electrodes 5 is determined to have low plating adhesion.

As a result of the above-described test, as illustrated in FIG. 6, in the samples S13 to S15 and S21, the specimen having low denseness was not confirmed. In the sample S16, the specimen having low denseness of each of the conductor region E11 and the conductor region E12 was not confirmed. However, in the sample S16, the specimen with the void near the boundary between the conductor region E11 and the conductor region E12 was confirmed, although only one was confirmed. In each of the samples S17 and S18, the specimens having low denseness of the conductor region E12 was confirmed, although only four was confirmed. In each of the samples S19 and S20, the specimens having low denseness of the conductor region E11 was confirmed, although only four was confirmed.

In the samples S13 to S20, the specimen having low plating adhesion was not confirmed. In contrast, in the sample S21, the specimen having low plating adhesion was confirmed, although only three was confirmed.

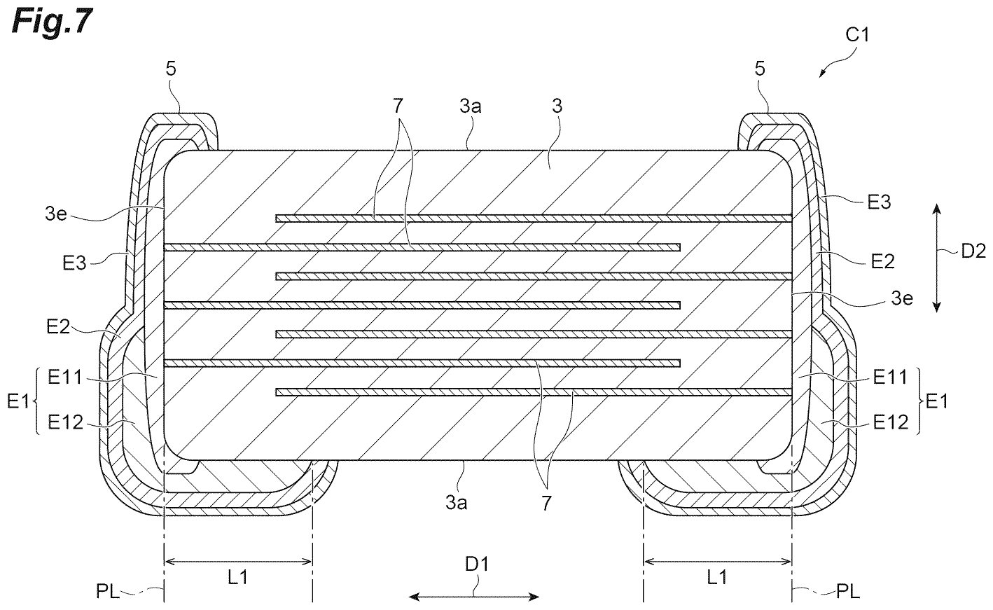

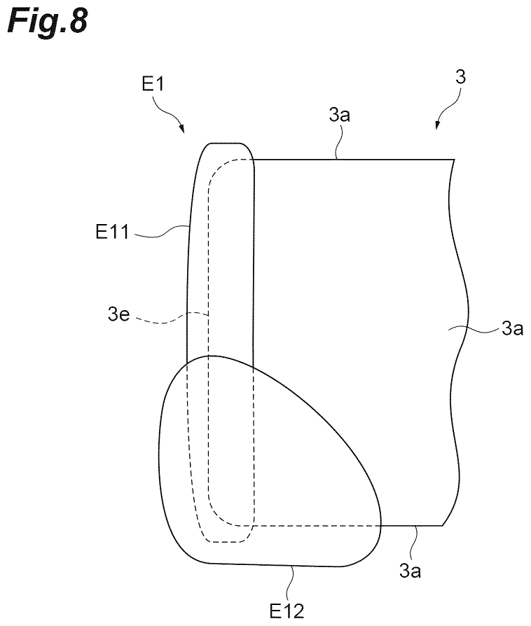

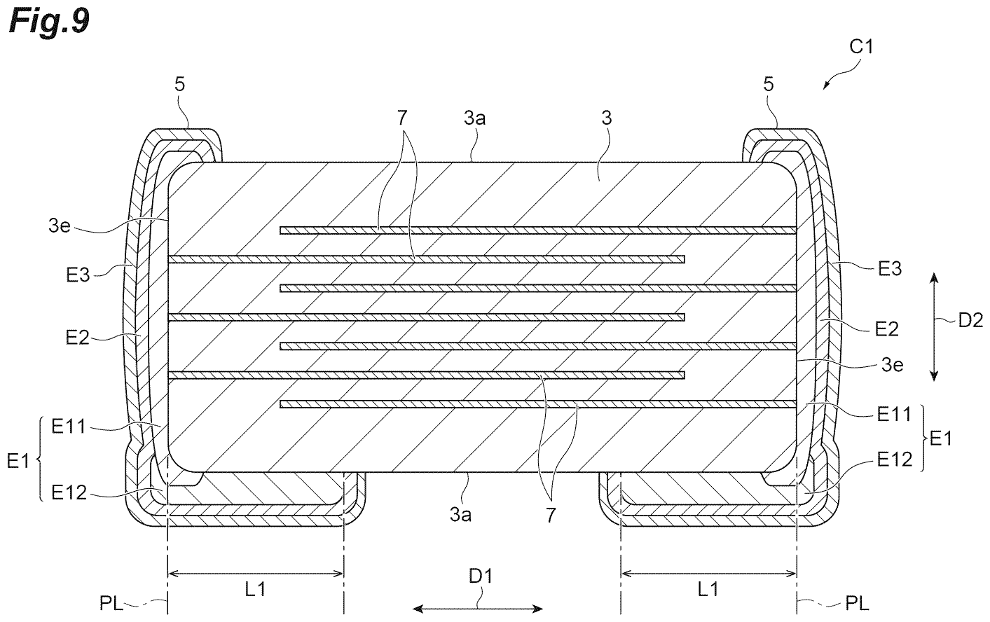

Configurations of multilayer capacitors C1 according to a plurality of modified examples of the present example will be described with reference to FIGS. 7 to 9. FIG. 7 is a view illustrating a cross-sectional configuration of a multilayer capacitor according to a modified example of the present example. FIG. 8 is a view illustrating a first electrode layer. FIG. 9 is a view illustrating a cross-sectional configuration of a multilayer capacitor according to another modified example of the present example. The multilayer capacitors C1 according to the modified examples are generally similar to or the same as the multilayer capacitor C1 according to the above-described example. However, the multilayer capacitors C1 according to the modified examples are different from the multilayer capacitor C1 according to the above-described example in a configuration of the conductor region E12. Hereinafter, differences between the above-described example and the modified examples will be mainly described.

As illustrated in FIGS. 7 and 8, the conductor region E12 is disposed to cover only a part of the conductor region E11. The conductor region E12 is disposed on the element body 3 and on the conductor region E11 to continuously cover only a part of the side surface 3e, only a part of a side surface 3a adjacent to the side surface 3e, and only a part of each of a pair of side surfaces 3a adjacent to the side surface 3e and opposing each other. The element body 3 includes three side surfaces 3a on which the conductor region E12 is disposed and one side surface 3a on which the conductor region E12 is not disposed. The side surface 3a opposing the one side surface 3a on which the conductor region E12 is not disposed is arranged to constitute the mounting surface. The conductor region E12 is disposed on the side surface 3a arranged to constitute the mounting surface.

A length L1 of the conductor region E12 disposed on the side surface 3a arranged to constitute the mounting surface is, for example, larger than a length L2 of the conductor region E12 disposed on the side surface 3a opposing the side surface 3a arranged to constitute the mounting surface. In this modified example, the conductor region E12 is not disposed on the side surface 3a opposing the side surface 3a arranged to constitute the mounting surface. Therefore, the length L2 is zero and the length L1 is larger than the length L2. The length L2 is not illustrated because it is zero.

A region, of each of the pair of side surfaces 3a opposing each other, covered with the conductor region E12 is positioned closer to the side surface 3a arranged to constitute the mounting surface and the side surface 3e. A region, of the side surface 3e, covered with the conductor region E12 is positioned closer to the side surface 3a arranged to constitute the mounting surface. A region, of the side surface 3a arranged to constitute the mounting surface, covered with the conductor area E12 is positioned closer to the side surface 3e. The conductor region E11 includes a region covered with the conductor region E12 and a region exposed from the conductor region E12. The region, of the conductor region E11, covered with the conductor region E12 is positioned closer to the side surface 3a arranged to constitute the mounting surface.

The second electrode layer E2 is disposed on the conductor region E11 and on the conductor region E12. The second electrode layer E2 entirely covers the conductor region E12 and entirely covers the region, of the conductor region E11, exposed from the conductor region E12. The second electrode layer E2 is in contact with the entire conductor-region E12, and is also in contact with the entire portion of the conductor-region E11 exposed from the conductor-region E12. The second conductive layer E2 is in direct contact with the conductor region E11 and the conductor region E12.

As illustrated in FIG. 9, the conductor region E12 is disposed to cover only a part of the conductor region E11. The conductor region E12 is disposed on the element body 3 and on the conductor region E11 to continuously cover only a part of the side surface 3a arranged to constitute the mounting surface and only the ridge portion between the side surface 3e and the side surface 3a arranged to constitute the mounting surface. The conductor region E12 may be disposed on the element body 3 to cover only a part of the side surface 3a arranged to constitute the mounting surface. The conductor region E12 may be disposed on the element body 3 to cover the ridge portions between the side surface 3a arranged to constitute the mounting surface and the pair of side surfaces 3a opposing each other.

If the conductor region E12 tends to separate from the element body 3 when the external force acts on the first electrode layer E1, the stress tends not to concentrate on the edge of the conductor region E12. That is, a crack tends not to occur in the element body 3. Therefore, when the external force acts on the first electrode layer E1, the conductor region E12 is required to tends to separate from the element body 3.

If the conductor region E11 tends to separate from the element body 3, the connection between the internal electrode 7 and the conductor region E11 may be severed. In the multilayer capacitor C1 in which the connection between the internal electrode 7 and the conductor region E11 is severed, the characteristics deteriorate. Therefore, even when the external force acts on the first electrode layer E1, the conductor region E11 is required to tend not to separate from the element body 3.

The glass composition GC included in the first electrode layer E1 increases bonding strength between the first electrode layer E1 and the element body 3. Among oxides included in the glass composition GC, SiO₂ and Al₂O₃ affect the bonding strength between the first electrode layer E1 and the element body 3. A configuration in which the first electrode layer E1 includes the glass composition GC with the total content of SiO₂ and Al₂O₃ of 23 mol % or more maintains the bonding strength between the first electrode layer E1 and the element body 3. In contrast, a configuration in which the first electrode layer E1 includes the glass composition GC with the total content of SiO₂ and Al₂O₃ of 5 mol % or more and 20 mol % or less reduces the bonding strength between the first electrode layer E1 and the element body 3.

In the multilayer capacitor C1, the glass composition GC included in the conductor region E12 has the total content of SiO₂ and Al₂O₃ of 5 mol % or more and 20 mol % or less. Therefore, when the external force acts on the first electrode layer E1, the conductor region E12 tends to separate from the element body 3. The stress tends not to concentrate on the edge of the conductor region E12, on the side surface 3a. Consequently, the multilayer capacitor C1 prevents a crack from occurring in the element body 3.

In the multilayer capacitor C1, the glass composition GC included in the conductor region E11 has the total content of SiO₂ and Al₂O₃ of 23 mol % or more. Therefore, even when the external force acts on the first electrode layer E1, the conductor region E11 tends not to separate from the element body 3. Consequently, the multilayer capacitor C1 prevents deterioration of characteristics.

In the multilayer capacitor C1, in the conductor region E12, the glass composition GC may have the content of larger than 5 vol % and less than 25 vol % relative to the total of the glass composition GC and the electrically conductive metal ME.

In a configuration in which, in the conductor region E12, the glass composition GC has the content of larger than 5 vol % relative to the total of the glass composition GC and the electrically conductive metal ME, this configuration reliably maintains denseness of the conductor region E12.

In a configuration in which, in the conductor region E12, the glass composition GC has the content of less than 25 vol % relative to the total of the glass composition GC and the electrically conductive metal ME, this configuration can reliably maintain plating adhesion even when forming the second electrode layer E2 on the conductor region E12.

In the multilayer capacitor C1, in the conductor region E11, the glass composition GC may have the content of larger than 5 vol % and less than 25 vol % relative to the total of the glass composition GC and the electrically conductive metal ME.

In a configuration in which, in the conductor region E11, the glass composition GC has the content of larger than 5 vol % relative to the total of the glass composition GC and the electrically conductive metal ME, this configuration reliably maintains denseness of the conductor region E11.

In a configuration in which, in the conductor region E11, the glass composition GC has the content of less than 25 vol % relative to the total of the glass composition GC and the electrically conductive metal ME, this configuration can reliably maintain plating adhesion even when forming the second electrode layer E2 on the conductor region E11, in the same manner as when forming the second electrode layer E2 on the conductor region E12. The plating adherence in a configuration in which the second electrode layer E2 is formed on the conductor region E11 is not confirmed. However, based on the results of the samples S4 to S8 described above, it is understood that the same result can be obtained even when forming the second electrode layer E2 on the conductor region E11.

In the multilayer capacitor C1, in each of the conductor region E11 and the conductor region E12, the glass composition GC may have the content of larger than 5 vol % and less than 25 vol % relative to the total of the glass composition GC and the electrically conductive metal ME.

In a configuration in which, in each of the conductor region E11 and the conductor region E12, the glass composition GC has the content of larger than 5 vol % relative to the total of the glass composition GC and the electrically conductive metal ME, this configuration reliably maintains the denseness of each of the conductor region E11 and the conductor region E12.

In a configuration in which, in each of the conductor region E11 and the conductor region E12, the glass composition GC has the content of less than 25 vol % relative to the total of the glass composition GC and the electrically conductive metal ME, this configuration can reliably maintain the plating adhesion even when forming the second electrode layer E2 on the conductor region E11 and the conductor region E12.

In the multilayer capacitor C1, the difference in the content of the glass composition GC between the conductor region E11 and the conductor region E12 may be 0 to 7 vol %.

In a configuration in which the difference in the content of the glass composition GC between the conductor region E11 and the conductor region E12 is 0 to 7 vol %, this configuration further reliably maintains the denseness of the first electrode layer E1.

In the multilayer capacitor C1, the conductor region E12 may be continuously disposed on the conductor region E11.

In a configuration in which the conductor region E12 is continuously disposed on the conductor region E11, the conductor region E11 further tends not to separate from the element body 3.

In the multilayer capacitor C1, the conductor region E12 may be disposed to entirely cover the conductor region E11.

In a configuration in which the conductor region E12 is disposed to entirely cover the conductor region E11, the conductor region E11 even further tends not to separate from the element body 3.

In the multilayer capacitor C1, the length L1 of the conductor region E12 may be larger than the length L2 of the conductor region E12.

In a configuration in which the length L1 of the conductor region E12 is larger than the length L2 of the conductor region E12, this configuration can cause directionality in mounting the multilayer capacitor C1. Therefore, in this configuration, one of the pair of side surfaces 3a can be reliably arranged to constitute the mounting surface. For example, one of the first pair of side surfaces 3a can be reliably arranged to constitute the mounting surface.

In the multilayer capacitor C1, the conductor region E12 may be not disposed on the side surface 3a opposing the side surface 3a arranged to constitute the mounting surface.

In a configuration in which the conductor region E12 is not disposed on the side surface 3a opposing the side surface 3a arranged to constitute the mounting surface, one of the pair of side surfaces 3a can be further reliably arranged to constitute the mounting surface. For example, one of the first pair of side surfaces 3a can be reliably arranged to constitute the mounting surface.

It is to be understood that not all aspects, advantages and features described herein may necessarily be achieved by, or included in, any one particular example. Indeed, having described and illustrated various examples herein, it should be apparent that other examples may be modified in arrangement and detail.

In the present examples and modified examples, the electronic component includes the multilayer capacitor. However, applicable electronic component is not limited to the multilayer capacitor. The applicable electronic component includes, for example, a multilayer electronic component such as a multilayer inductor, a multilayer varistor, a multilayer piezoelectric actuator, a multilayer thermistor, a multilayer solid-state battery component, or a multilayer composite component, or electronic components other than the multilayer electronic components.

What is claimed is:

1. An electronic component comprising:
an element body including a first side surface and a pair of second side surfaces adjacent to the first side surface and opposing each other;
an internal conductor disposed in the element body and including an end exposed to the first side surface; and
an external conductor disposed on the element body and including a glass composition and an electrically conductive metal, the glass composition including SiO₂ and Al₂O₃, wherein
the external conductor includes:
a first region disposed on the first side surface and connected to the end included in the internal conductor; and
a second region disposed on at least one of the pair of second side surfaces,
the glass composition included in the first region has a total content of SiO₂ and Al₂O₃ of 23 mol % or more, and
the glass composition included in the second region has a total content of SiO₂ and Al₂O₃ of 5 mol % or more and 20 mol % or less.

2. The electronic component according to claim 1, wherein
in the first region, the glass composition has a content of larger than 5 vol % and less than 25 vol % relative to a total of the glass composition and the electrically conductive metal.

3. The electronic component according to claim 1, wherein
in the second region, the glass composition has a content of larger than 5 vol % and less than 25 vol % relative to a total of the glass composition and the electrically conductive metal.

4. The electronic component according to claim 1, wherein
in each of the first region and the second region, the glass composition has a content of larger than 5 vol % and less than 25 vol % relative to a total of the glass composition and the electrically conductive metal.

5. The electronic component according to claim 4, wherein
a difference in the content of the glass composition between the first region and the second region is 0 to 7 vol %.

6. The electronic component according to claim 1, wherein
the second region is continuously disposed on the first region.

7. The electronic component according to claim 6, wherein
the second region is disposed to entirely cover the first region.

8. The electronic component according to claim 1, wherein
a length of the second region disposed on one of the pair of second side surfaces is larger than a length of the second region disposed on an other of the pair of second side surfaces.

9. The electronic component according to claim 8, wherein
the second region is not disposed on the other of the pair of second side surfaces.

10. The electronic component according to claim 1, further comprising:
a metal plating layer disposed outside the external conductor.
